(19) United States
(12) Patent Application Publication
(10) Pub. No.: US 2007/0142608 A1
(43) Pub. Date: Jun. 21, 2007

(54) Process for the preparation of polyaddition compounds

(76) Inventors: Hans Josef Laas, Odenthal (DE); Bernd Sojka, Koln (DE); Michael Grahl, Leverkusen (DE); Josef Sanders, Leverkusen (DE); Wolfgang Fischer, Meerbusch (DE); Reinhard Halpaap, Odenthal (DE)

Correspondence Address: BAYER MATERIAL SCIENCE LLC, 100 BAYER ROAD, PITTSBURGH, PA, 15205, US

(21) Appl. No.: 11/638,626

(22) Filed: Dec. 13, 2006

(30) Foreign Application Priority Data
Dec. 20, 2005 (DE) 102005060828.0

(51) Int. Cl. C08G 18/00

(52) U.S. Cl. 528/44

(57) ABSTRACT

The present invention relates to a novel process for the preparation of polyaddition products, to the products obtainable by this process and to their use as starting components in the production of polyurethane plastics. The process includes the reaction of A) polyisocyanates with uretdione groups having a mean isocyanate functionality of at least 2.0, optionally with the concomitant use of B) other diisocyanates and/or polyisocyanates, different from A, in an amount of up to 70 wt. %, based on the total weight of components A) and B), with C) polyols in the molecular weight range 62-2000 having a mean functionality of at least 2.0, or mixtures of polyols and optionally D) other isocyanate-reactive monofunctional compounds in an amount of up to 40 wt. %, based on the total weight of components C) and D). An equivalent ratio of isocyanate groups to isocyanate-reactive groups of 1.8:1 to 0.6:1 is maintained in the reactants, and the reaction is carried out in the presence of at least one bismuth-containing catalyst.

### CROSS-REFERENCE TO RELATED APPLICATION

This application claims priority under 35 U.S.C. §119 (a-d) to German application DE 102005060828, filed Dec. 20, 2005.

### FIELD OF THE INVENTION

The present invention relates to a novel process for the preparation of polyaddition products, to the products obtainable by this process and to their use as starting components in the production of polyurethane plastics.

### BACKGROUND OF THE INVENTION

Polyaddition compounds with uretdione groups are increasingly being used as blocker-free crosslinking agents for highly weather-resistant polyurethane (PUR) powder coatings. The crosslinking principle utilized by these compounds is thermal recleavage of the uretdione structures into free isocyanate groups and their subsequent reaction with a hydroxy-functional binder.

The preparation of powder coating crosslinking agents containing uretdione groups has been known for a long time. It is normally carried out by reacting polyisocyanates or polyisocyanate mixtures containing uretdione groups with difunctional and optionally monofunctional compounds carrying isocyanate-reactive groups. This reaction can be carried out batchwise or by a continuous process, e.g. in special apparatuses such as intimate kneaders or static mixers, and is preferably accelerated by the concomitant use of suitable catalysts. EP-A 0 045 994 and EP-A 0 045 998 describe e.g. the use of tin(II) and tin(IV) compounds, such as tin(II) acetate, tin(II) octoate, tin(II) laurate, dibutyltin(IV) diacetate, dibutyltin(IV) dilaurate (DBTL), dibutyltin(IV) maleate or dioctyltin(IV) diacetate, as catalysts in the preparation of polyaddition products containing uretdione groups. In addition to the tin compounds tin(II) ethylcaproate and tin(II) palmitate, EP-A 1 083 209 also mentions zinc compounds, such as zinc chloride and zinc 2-ethylcaproate, metal salts, such as iron(III) chloride or molybdenum glycolate, and tertiary amines, such as triethylamine, pyridine, methylpyridine, benzyldimethylamine, N,N-endoethylenepiperazine, N-methylpiperidine, pentamethyldiethylenetriamine, N,N-dimethylaminocyclohexane and N,N′-dimethylpiperazine, as suitable catalysts for accelerating the urethanization reaction.

The uretdione powder coating crosslinking agents commercially available at the present time are normally prepared under DBTL catalysis.

A major area of application for uretdione powder coating crosslinking agents is that of powder coatings which give matt or semi-matt surfaces on curing. Such matt powder coatings are used e.g. for coating office furniture, electrical and electronic equipment, domestic appliances or motor vehicle add-on parts. Glossy, strongly reflecting lacquer systems are also frequently undesirable for coating cladding panels.

A common method of formulating polyurethane matt powder coatings consists in the coextrusion (one-shot process) of two hydroxy-functional polyester powder binders, which have very different OH numbers and hence different reactivities, with an IPDI-based uretdione powder coating crosslinking agent (cf. e.g.: P. Thometzek et al.: “Tailor-made Polyurethane Powders for High-quality Coatings”, PCE Powder Coating Europe 2000, Amsterdam, The Netherlands, Jan. 19-20, 2000). Depending on the type and proportion of the polyols used, it is possible reliably and reproducibly to obtain powder coatings with excellent flow and 60° gloss values of 15 to 20% which exhibit the familiarly good mechanical and chemical stabilities of polyurethane powder coatings.

Following this principle, using the commercially available uretdione powder coating hardeners in combination with selected binder components, it is even possible to formulate powder coatings with 60° gloss values below 10%. However, these special formulations are noticeably susceptible even to small quality variations in the raw materials used and are often difficult to reproduce in respect of their gloss value.

### SUMMARY OF THE INVENTION

The object of the present invention was therefore to provide novel polyaddition compounds with uretdione groups from which, by the one-shot process, in combination with two polyesterpolyols of different reactivity, powder coatings can be formulated which produce coatings of markedly lower gloss than was possible with the uretdione powder coating hardeners known hitherto, and which thus ensure an adequate reliability of reproduction, even for extremely matt powder coating formulations.

This object could now be achieved with the provision of the novel process described in greater detail below and the novel products obtainable by this process. The process according to the invention described in greater detail below is based on the surprising observation that, after coextrusion with two powder coating binders of different OH number, blocker-free uretdione powder coating crosslinking agents which have been prepared in the presence of bismuth-containing catalysts give powder coatings which produce a markedly lower gloss, in the same lacquer formulation, than the hitherto available uretdione powder coating crosslinking agents of the same gross composition prepared under DBTL catalysis.

The present invention provides a process for the preparation of polyaddition products containing uretdione groups by the reaction of
A) polyisocyanates with uretdione groups having a mean isocyanate functionality of at least 2.0, optionally with the concomitant use of
B) other diisocyanates and/or polyisocyanates in an amount of up to 70 wt. %, based on the total weight of components A) and B), with
C) polyols in the molecular weight range 62-2000 having a (mean) functionality of at least 2.0, or mixtures of polyols and optionally
D) other isocyanate-reactive monofunctional compounds in an amount of up to 40 wt. %, based on the total weight of components C) and D),
   while maintaining an equivalent ratio of isocyanate groups to isocyanate-reactive groups of 1.8:1 to 0.6:1, characterized in that the reaction is carried out in the presence of at least one bismuth-containing catalyst.

It is surprising here that only with the uretdione powder coating crosslinking agents prepared according to the invention using bismuth-containing catalysts is it possible to obtain coats of lacquer which reproducibly afford a hitherto unattainable mattness of powder coatings. This property has not so far been correlated with detectable material parameters of the crosslinking agent.

The invention also provides the polyaddition products containing uretdione groups obtainable by this process and their use as starting components in the production of polyurethane plastics, especially as crosslinking components in heat-curable polyurethane powder coatings.

Finally, the invention also provides the use of the polyaddition products containing uretdione groups obtainable according to the invention, in combination with at least one polyol having an OH number of 20 to 40 mg KOH/g and at least one polyol having an OH number of 200 to 300 mg KOH/g, for the production of powder coatings with a matt surface.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The starting compounds A) for the process according to the invention are any polyisocyanates with uretdione groups having a mean isocyanate functionality of at least 2.0, such as those obtainable in known manner by the catalytic dimerization of some of the isocyanate groups of simple diisocyanates, preferably followed by separation of the unreacted excess diisocyanate, for example by thin film distillation. Suitable diisocyanates for the preparation of the starting compounds A) are any diisocyanates with aliphatically, cycloaliphatically, araliphatically and/or aromatically bonded isocyanate groups, which can be prepared by any processes, e.g. by phosgenation or in a phosgene-free manner, for example by urethane cleavage. Examples of suitable starting diisocyanates are those in the molecular weight range 140 to 400, such as 1,4-diisocyanatobutane, 1,6-diisocyanatohexane (HDI), 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane, 4,4′-diisocyanato-3,3′-dimethyldicyclohexylmethane, 4,4′-diisocyanato-3,3′,5,5′-tetramethyl-dicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(1-isocyanato-1-methyl-ethyl)benzene (TMXDI), bis(4-(1-isocyanato-1-methylethyl)phenyl)carbonate, 1,3- and 1,4-phenylene diisocyanate, 2,4- and 2,6-toluylene diisocyanate and any mixtures of these isomers, diphenylmethane-2,4′- and/or -4,4′-diisocyanate and naphthylene-1,5-diisocyanate, and any mixtures of such diisocyanates. Other suitable diisocyanates can also be found e.g. in Justus Liebigs Annalen der Chemie, volume 562 (1949) pp 75-136.

Any compounds that catalyze the dimerization of isocyanate groups are suitable, in principle, as catalysts for the preparation of the starting compounds A) from said diisocyanates, examples being tertiary organic phosphines of the type mentioned in U.S. Pat. No. 4,614,785 column 4, lines 11 to 47, or DE-A 1 934 763 and 3 900 053, tris(dialkylamino)phosphines of the type mentioned in DE-A 3 030 513, DE-A 3 227 779 and DE-A 3 437 635, substituted pyridines of the type mentioned in DE-A 1 081 895 and DE-A 3 739 549, azolates of the type mentioned in WO 02/092657, WO 03/093246 and WO 04/005364, or substituted imidazoles or benzimidazoles of the type mentioned in EP-A 0 417 603.

Preferred starting compounds A) for the process according to the invention are polyisocyanates with uretdione groups which are based on diisocyanates with aliphatically and/or cycloaliphatically bonded isocyanate groups of the type mentioned above as examples, or mixtures of such polyisocyanates.

It is particularly preferable to use polyisocyanates with uretdione groups which are based on HDI, IPDI, 2,4′-diisocyanatodicyclohexylmethane and/or 4,4′-diisocyanatodicyclohexylmethane.

In the preparation, known per se, of the polyisocyanates with uretdione groups by the catalytic dimerization of the diisocyanates mentioned as examples, the dimerization reaction is often accompanied by a less extensive trimerization reaction with the formation of polyisocyanates with isocyanurate groups which are more than difunctional, resulting in the fact that the mean NCO functionality of component A), based on the free NCO groups, is preferentially 2.0 to 2.5.

It is optionally possible for other diisocyanates and/or polyisocyanates B) to be used concomitantly in the process according to the invention. These are e.g. the above-described monomeric diisocyanates with aliphatically, cycloaliphatically, araliphatically and/or aromatically bonded isocyanate groups which are suitable for the preparation of the starting compounds A), or any mixtures of such diisocyanates, and polyisocyanates of isocyanurate, urethane, allophanate, biuret and/or oxadiazinetrione structure which are prepared by modification of these monomeric diisocyanates, such as those described as examples in e.g. DE-A 1 670 666, DE-A 3 700 209, DE-A 3 900 053, EP-A 0 336 205 and EP-A 0 339 396.

These diisocyanates and/or polyisocyanates B), if present, are used concomitantly in amounts of up to 70 wt. %, preferably of up to 50 wt. %, based on the total weight of components A) and B).

Other mixtures of starting components A) and B) that are suitable for the process according to the invention are solutions of polyisocyanates with uretdione groups in monomeric diisocyanates, such as those obtained in the above-described preparation of the starting compounds A) when the excess unreacted diisocyanates are not separated off after proportionate catalytic dimerization. In this case the proportion of diisocyanates B) in the total amount of starting components A) and B) can again be up to 70 wt. %.

Preferred starting components B) which can optionally be used concomitantly in the process according to the invention are diisocyanates and polyisocyanates with aliphatically and/or cycloaliphatically bonded isocyanate groups. It is particularly preferable to use monomeric HDI, IPDI and/or 4,4′-diisocyanatodicyclohexylmethane, or polyisocyanates from these diisocyanates with an isocyanurate structure.

Starting compounds C) for the process according to the invention are any polyols in the molecular weight range 62-2000 which have a (mean) OH functionality of at least 2.0, or mixtures of such polyols.

Examples of suitable polyols C) are simple polyhydric alcohols in the molecular weight range 62 to 400, such as 1,2-ethanediol, 1,2- and 1,3-propanediol, the isomeric butanediols, pentanediols, hexanediols, heptanediols and octanediols, 1,10-decanediol, 1,12-dodecanediol, 1,2- and 1,4-cyclohexanediol, 1,4-cyclohexanedimethanol or 4,4′-(1-methylethylidene)biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol or 1,3,5-tris(2-hydroxyethyl)isocyanurate, and also simple esteralcohols or etheralcohols, e.g. hydroxypivalic acid neopentyl glycol ester, diethylene glycol or dipropylene glycol.

Other suitable starting compounds C) are the polyhydroxyl compounds of the polyester, polycarbonate, polyestercarbonate or polyether type which are known per se.

Examples of polyesterpolyols suitable as polyol components C) are those having an average molecular weight (calculable from functionality and hydroxyl number) of 200 to 2000, preferably of 250 to 1500, with a hydroxyl group content of 1 to 21 wt. %, preferably of 2 to 18 wt. %, such as those which can be prepared in a manner known per se by reacting polyhydric alcohols, e.g. those mentioned above in the molecular weight range 62 to 400, with substoichiometric amounts of polybasic carboxylic acids, corresponding carboxylic acid anhydrides, corresponding polycarboxylic acid esters of lower alcohols, or lactones.

The acids or acid derivatives used to prepare the polyesterpolyols can be of an aliphatic, cycloaliphatic and/or aromatic nature and can optionally be substituted, e.g. by halogen atoms, and/or unsaturated. Examples of suitable acids are polybasic carboxylic acids in the molecular weight range 118 to 300, or derivatives thereof such as succinic acid, adipic acid, sebacic acid, phthalic acid, isophthalic acid, terephthalic acid, trimellitic acid, phthalic anhydride, tetrahydrophthalic acid, hexahydrophthalic acid, maleic acid, maleic anhydride, dimeric and trimeric fatty acids, dimethyl terephthalate and terephthalic acid bisglycol ester.

The polyesterpolyols can also be prepared using any mixtures of these starting compounds mentioned as examples.

A type of polyesterpolyol that is preferably used as the polyol component C) consists of those which can be prepared in a manner known per se, with ring opening, from lactones and simple polyhydric alcohols, e.g. those mentioned above as examples, as starter molecules. Examples of suitable lactones for the preparation of these polyesterpolyols are β-propiolactone, γ-butyrolactone, γ- and δ-valerolactone, ε-caprolactone, 3,5,5- and 3,3,5-trimethylcaprolactone, or any mixtures of such lactones.

Polyhydroxyl compounds of the polycarbonate type which are suitable as polyols C) are especially the polycarbonatediols known per se, such as those which can be prepared e.g. by reacting dihydric alcohols, e.g. those mentioned above as examples in the list of polyhydric alcohols in the molecular weight range 62 to 400, with diaryl carbonates, e.g. diphenyl carbonate, dialkyl carbonates, e.g. dimethyl carbonate, or phosgene.

Polyhydroxyl compounds of the polyestercarbonate type which are suitable as polyols C) are especially the diols with ester groups and carbonate groups known per se, such as those obtainable e.g. according to the teaching of DE-A 1 770 245 or WO 03/002630 by reacting dihydric alcohols with lactones of the type mentioned above as examples, especially ε-caprolactone, and then reacting the resulting polyesterdiols with diphenyl carbonate or dimethyl carbonate.

Polyetherpolyols suitable as polyols C) are especially those having an average molecular weight (calculable from functionality and hydroxyl number) of 200 to 2000, preferably of 250 to 1500, with a hydroxyl group content of 1.7 to 25 wt. %, preferably of 2.2 to 20 wt. %, such as those obtainable in a manner known per se by the alkoxylation of suitable starter molecules. These polyetherpolyols can be prepared using any polyhydric alcohols, such as those described above in the molecular weight range 62 to 400, as starter molecules. Alkylene oxides suitable for the alkoxylation reaction are especially ethylene oxide and propylene oxide, which can be used in any order or as a mixture in the alkoxylation reaction.

Other suitable polyetherpolyols are the polyoxytetramethylene glycols known per se, such as those obtainable e.g. by the polymerization of tetrahydrofuran according to Angew. Chem. 72, 927 (1960).

Other suitable starting compounds C) are dimeric diols such as those which can be prepared in a manner known per se, e.g. by the hydrogenation of dimeric fatty acids and/or esters thereof according to DE-A 1 768 313 or others of the processes described in EP-A 0 720 994, page 4, line 33 to line 58.

Preferred starting compounds C) for the process according to the invention are the above-mentioned simple polyhydric alcohols in the molecular weight range 62 to 400, the polyesterpolyols or polycarbonatepolyols mentioned and any mixtures of these polyol components.

It is particularly preferable, however, to use the diols in the molecular weight range 62 to 300 mentioned above in the list of simple polyhydric alcohols, polyesterdiols or polycarbonates in the molecular weight range 134 to 1200, or mixtures thereof.

Very particularly preferred starting compounds C) for the process according to the invention are mixtures of said polyesterdiols with up to 80 wt. %, preferably up to 60 wt. %, based on the total weight of polyols C) used, of simple diols in the molecular weight range 62 to 300.

Other isocyanate-reactive monofunctional compounds D) can optionally also be used concomitantly in the process according to the invention. In particular, these are simple aliphatic or cycloaliphatic monoamines, such as methylamine, ethylamine, n-propylamine, isopropylamine, the isomeric butylamines, pentylamines, hexylamines and octylamines, n-dodecylamine, n-tetradecylamine, n-hexadecylamine, n-octadecylamine, cyclohexylamine, the isomeric methylcyclohexylamines and aminomethylcyclohexane, secondary monoamines, such as dimethylamine, diethylamine, dipropylamine, diisopropylamine, dibutylamine, diisobutylamine, bis(2-ethylhexyl)amine, N-methyl- and N-ethylcyclohexylamine and dicyclohexylamine, or monoalcohols, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols and hydroxymethylcyclohexane.

If present, these monofunctional compounds D) are used in amounts of up to 40 wt. %, preferably 25 wt. %, based on the total amount of isocyanate-reactive starting compounds C) and D).

Preferred starting compounds D) for the process according to the invention are the simple aliphatic or cycloaliphatic monoalcohols of the type mentioned.

In the process according to the invention, the polyisocyanates A) with uretdione groups, optionally with the concomitant use of other diisocyanates and/or polyisocyanates B), are reacted with the polyols C) and optionally other isocyanate-reactive monofunctional compounds D), in the presence of at least one bismuth-containing catalyst.

These catalysts are any inorganic or organic bismuth compounds, for example bismuth(III) oxide, bismuth(III) sulfide, bismuth(III) nitrate, basic bismuth(III) carbonate, bismuth(III) sulfate, bismuth(III) phosphate, bismuth(III) molybdate, bismuth(III) vanadate, bismuth(III) titanate, bismuth(III) zirconate, bismuth borate, bismuth halides, e.g. bismuth(III) chloride, bismuth(III) bromide, bismuth(III) iodide and bismuth(III) and bismuth(V) fluoride, bismuth(III) oxo-halides, e.g. bismuth(III) oxo-chloride, bismuth(III) oxo-iodide and bismuth(III) oxo-fluoride, sodium bismuthate, bismuth(III) carboxylates, e.g. bismuth(III) acetate, bismuth(III) 2-ethylhexanoate, bismuth(III) octoate, bismuth(III) neodecanoate, bismuth(III) oleate, bismuth(III) subgallate, bismuth subsalicylate, bismuth lactate, bismuth(III) citrate, bismuth benzoate, bismuth oxalate, bismuth succinate and bismuth tartrates, bismuth(III) oxo-acetate, bismuth(III) trifluoromethanesulfonate, bismuth(III) 2,2,6,6-tetramethyl-3,5-heptanedionate, bismuth(III) hexafluoroacetylacetonate, bismuth β-naphthol, trimethylbismuth, tributylbismuth, triphenylbismuth, diphenylmethylbismuth, tris(2-methoxyphenyl)bismuth, tris(4-ethoxyphenyl)bismuth, tris(4-tolyl)bismuth, bismuth 2-ethylhexane diisopropoxide, bis(2-ethylhexyloxy)bismuth isopropoxide, bismuth(III) tert-pentoxide, bismuth ethoxide, bismuth n-propoxide, bismuth isopropoxide, bismuth n-butoxide, bismuth 2-methoxyethoxide, triphenylbismuth diacetate, triphenylbismuth dichloride, tris(2-methoxyphenyl)bismuth dichloride, triphenylbismuth carbonate, bismuth N,N-dimethyldithiocarbamate or any mixtures of such compounds.

Preferred catalysts are bismuth(III) carboxylates of the type mentioned above as examples, especially bismuth salts of aliphatic monocarboxylic acids having up to 16 carbon atoms in the aliphatic radical. It is very particularly preferable to use bismuth(III) 2-ethylhexanoate, bismuth(III) octoate and/or bismuth(III) neodecanoate.

These catalysts are used in the process according to the invention in amounts of 0.001 to 2.0 wt. %, preferably of 0.01 to 0.2 wt. %, based on the total amount of starting compounds used.

In addition to the bismuth-containing catalysts essential to the invention, other catalysts can optionally also be used concomitantly in the process according to the invention, examples being the conventional catalysts known from polyurethane chemistry, e.g. tertiary amines, such as triethylamine, pyridine, methylpyridine, benzyldimethylamine, N,N-endoethylenepiperazine, N-methylpiperidine, pentamethyldiethylenetriamine, N,N-dimethylaminocyclohexane and N,N′-dimethylpiperazine, or metal salts, such as iron(III) chloride, zinc chloride, zinc 2-ethylcaproate, tin(II) octanoate, tin(II) ethylcaproate, dibutyltin(IV) dilaurate and molybdenum glycolate.

If present, these additional catalysts are used in an amount of up to 1.6 wt. %, preferably of up to 0.16 wt. %, based on the total amount of starting compounds used, with the proviso that the total amount of all the catalysts used in the process according to the invention is 0.001 to 2.0 wt. %, preferably from 0.01 to 0.2 wt. %, the proportion of bismuth-containing catalysts essential to the invention, based on this total amount of catalysts, being at least 20 wt. %.

Examples of other auxiliary substances and additives which can optionally be added to the starting compounds in the process according to the invention are the flow control agents known from powder coating technology, e.g. polybutyl acrylates or those based on polysilicones, light stabilizers, e.g. sterically hindered amines, UV absorbers, e.g. benztriazoles or benzophenones, and colour stabilizers to combat the danger of yellowing due to overstoving, e.g. trialkyl, triaryl and/or trisalkylphenyl phosphites optionally containing inert substituents.

To carry out the process according to the invention, the polyisocyanates A) with uretdione groups, optionally with the concomitant use of other diisocyanates and/or polyisocyanates B), are reacted with the polyols C) and optionally other isocyanate-reactive monofunctional compounds D), in the presence of a bismuth-containing catalyst, in a batch or continuous process, e.g. in special apparatuses such as intimate kneaders or static mixers, in said equivalent ratio of isocyanate groups to isocyanate-reactive groups of 1.8:1 to 0.6:1, preferably of 1.6:1 to 0.8:1, at a reaction temperature of 40 to 200° C., particularly preferably of 60 to 180° C., preferably until the theoretically calculated NCO content is reached.

The reaction preferably takes place in the melt, without a solvent, but it can of course also be carried out in a suitable solvent inert to isocyanate groups. Examples of suitable solvents for this less preferred procedure are the conventional lacquer solvents known per se, such as ethyl acetate, butyl acetate, ethylene glycol monomethyl or monoethyl ether acetate, 1-methoxy-2-propyl acetate, acetone, 2-butanone, 4-methyl-2-pentanone, cyclohexanone, toluene or mixtures thereof, as well as solvents such as propylene glycol diacetate, diethylene glycol dimethyl ether, diethylene glycol ethyl and butyl ether acetate, N-methylpyrrolidone and N-methylcaprolactam, or mixtures of such solvents.

When the reaction has ended, these solvents optionally used concomitantly have to be separated from the process product according to the invention by means of suitable methods, e.g. by precipitation and simple suction, spray drying or melt extrusion in a stripping screw.

Independently of the type of procedure, the process according to the invention yields polyaddition compounds containing uretdione groups with a content of free isocyanate groups (calculated as NCO; molecular weight=42) of 0 to 6.0 wt. %, preferably of 0 to 5.0 wt. % and particularly preferably of 0 to 4.0 wt. %, a content of uretdione groups (calculated as C₂N₂O₂; molecular weight=84) of 3 to 25 wt. %, preferably of 5 to 17 wt. % and particularly preferably of 6 to 17 wt. %, and a content of monomeric diisocyanates of less than 1.0 wt. %, preferably of less than 0.5 wt. % and particularly preferably of less than 0.3 wt. %, said contents depending on the chosen equivalent ratio of isocyanate groups to isocyanate-reactive groups; said polyaddition compounds are solid below 40° C. and liquid above 125° C. and, in particular, have a melting point or melting range (determined by differential thermal analysis (DTA)) which is within the temperature range 40 to 110° C., particularly preferably within the temperature range 50 to 100° C.

The polyaddition compounds according to the invention are valuable starting materials for the production of polyurethane plastics by the isocyanate polyaddition process. They are used especially as crosslinking components in heat-curable blocker-free PUR powder coatings where, depending on the chosen reactants, high-gloss to deep-matt coatings are obtained which have the familiarly good chemical and mechanical stabilities of polyurethane powder coatings. Compared with the uretdione powder coating crosslinking agents of analogous structure available hitherto, which were prepared without catalysis or e.g. under DBTL catalysis, the process products according to the invention are distinguished in particular by markedly lower gloss values in matt powder coatings obtainable by the so-called one-shot process. However, the gloss of high-gloss formulations is not adversely affected at the same time.

Reactants for the polyaddition compounds according to the invention which are suitable for the preparation of blocker-free powder coatings are basically any of the binders known from powder coating technology which have isocyanate-reactive groups such as hydroxyl, carboxyl, amino, thiol, urethane or urea groups. It is preferable, however, to use hydroxy-functional powder coating binders which are solid below 40° C. and liquid above 130° C. The softening points of these hydroxy-functional resins—determined by differential thermal analysis (DTA)—are preferably within the temperature range 30 to 120° C., particularly preferably within the temperature range 35 to 110° C.

Their hydroxyl numbers are generally between 15 and 350, preferably between 20 and 300, and their average molecular weight (calculable from functionality and hydroxyl content) is generally between 500 and 12,000, preferably between 700 and 7000.

Examples of such powder coating binders are polyesters, polyacrylates or polyurethanes containing hydroxyl groups, such as those described in the publications of the state of the art cited above, e.g. EP-A 0 045 998 or EP-A 0 254 152, as well as any mixtures of such resins.

Advantageously, the polyaddition compounds containing uretdione groups according to the invention are used in combination with binder mixtures consisting of at least one polyol having an OH number of 20 to 40 mg KOH/g and at least one polyol having an OH number of 200 to 300 mg KOH/g for the production of powder coatings with a matt surface.

To prepare a ready-to-use powder coating, the polyaddition compounds according to the invention are mixed with suitable hydroxy-functional powder coating binders, optionally treated with other auxiliary substances and additives, such as catalysts, pigments, fillers or flow control agents, and combined to form a homogeneous material, for example in extruders or kneaders at temperatures above the melting range of the individual components, e.g. at a temperature of 70 to 130° C., preferably of 70 to 110° C.

The polyaddition compounds according to the invention and the hydroxy-functional binders are used here in proportions such that there are 0.6 to 2.0, preferably 0.6 to 1.8 and particularly preferably 0.8 to 1.6 isocyanate groups per hydroxyl group, isocyanate groups being understood, in the case of the polyaddition compounds according to the invention, as meaning the sum of isocyanate groups present in dimeric form as uretdione groups, and free isocyanate groups.

The catalysts which are optionally to be used concomitantly to accelerate curing are e.g. the conventional compounds known from polyurethane chemistry, such as those already described above as catalysts which can optionally be used concomitantly in the process according to the invention in order to accelerate the reaction, amidines of the type mentioned in EP-A 0 803 524, dialkylmetal carboxylates or alcoholates or metal acetylacetonates of the type mentioned in EP-B 1 137 689, ammonium carboxylates of the type mentioned in EP-A 1 475 399, metal hydroxides or alcoholates of the type mentioned in EP-A 1 475 400, ammonium hydroxides or fluorides of the type mentioned in EP-A 1 522 548, or any mixtures of such catalysts. Furthermore, the above-mentioned bismuth-containing compounds essential as catalysts for the process according to the invention can optionally also be used concomitantly as curing catalysts in the preparation of the powder coatings.

These catalysts can optionally be added in amounts of 0.01 to 5.0 wt. %, preferably of 0.05 to 2.0 wt. %, based on the total amount of organic binder, i.e. polyaddition compounds according to the invention in combination with the hydroxy-functional powder coating binders, but excluding the other auxiliary substances and additives that may be used.

However, for the use, likewise according to the invention, of the polyaddition compounds containing uretdione groups obtainable by the process according to the invention, in combination with mixtures of binders of very different OH number, for the production of powder coatings with a matt surface, the concomitant use of curing catalysts is less preferable because the gloss value cannot be further reduced by the addition of either bismuth-containing catalysts or other PUR catalysts, e.g. DBTL. On the contrary, as shown in the Examples, catalysis of these matt powder coating formulations is even disadvantageous because the gloss increases markedly with increasing catalyst concentration.

After cooling to room temperature and after a suitable preliminary comminution, e.g. by chopping or coarse grinding, the extruded mass is ground to a powder coating and the fraction of particles above the desired size, e.g. above 0.1 mm, is removed by sieving.

The powder coating formulations prepared in this way can be applied to the substrate to be coated by means of conventional powder application processes, e.g. electrostatic powder spraying or fluidized bed coating. The coatings are cured by heating to temperatures of 100 to 220° C., but preferably at temperatures of 110 to 160° C. (which are low for polyurethane powder coatings) and particularly preferably at temperatures of 120 to 150° C., e.g. for a period of approx. 5 to 60 minutes.

This produces hard elastic coatings with good solvent and chemical resistance which are distinguished by an outstanding flow, the gloss being adjustable from high-gloss to deep-matt, as desired, by choosing the appropriate reactants.

The Examples which follow will serve to illustrate the invention further. All the percentages are by weight.

### EXAMPLES

Hereafter, all the percentages, except the gloss values, are by weight. The indicated contents of uretdione groups were determined by hot titration (refluxing for 30 minutes with excess di-n-butylamine in 1,2-dichlorobenzene, followed by back titration with hydrochloric acid).

Preparation of Starting Compounds A)

Polyisocyanate A1) With Uretdione Groups

Uretdione polyisocyanate prepared according to Example 3 of EP-B 0 896 973, based on 1-isocyanato-3,3,5-trimethyl-5-isocyanatomethylcyclohexane (IPDI), with a content of free NCO groups of 17.0%, a content of uretdione groups, determined by hot titration, of 20.5% and a content of monomeric IPDI of 0.4%.

Polyisocyanate A2) With Uretdione Groups

Uretdione polyisocyanate prepared according to Example 6 of WO 2004/005364, based on 4,4′-diisocyanatodicyclohexylmethane, with a content of free NCO groups of 14.2%, a content of uretdione groups, determined by hot titration, of 17.8% and a content of monomeric 4,4′-diisocyanatodicyclohexylmethane of 0.5%.

Preparation of Starting Compounds C)

Diol C1) With Ester Groups

901 g of 1,4-butanediol and 1712 g of ε-caprolactone are mixed at room temperature under dry nitrogen, 0.3 g of tin(II) octoate is added and the mixture is then heated for 5 h at 160° C. After cooling to room temperature, a colourless liquid product with the following characteristics is obtained:

| η (23° C.): | 180 mPas |
|---|---|
| OH number: | 416 mg KOH/g |
| free ε-caprolactone: | 0.1% |
| average molecular weight (calc. from OH number): | 269 |

Diol C2) With Ester Groups

761 g of 1,3-propanediol and 1712 g of ε-caprolactone are mixed at room temperature under dry nitrogen, 0.3 g of tin(II) octoate is added and the mixture is then heated for 5 h at 160° C. After cooling to room temperature, a colourless liquid product with the following characteristics is obtained:

| η (23° C.): | 190 mPas |
|---|---|
| OH number: | 449 mg KOH/g |
| free ε-caprolactone: | 0.3% |
| average molecular weight (calc. from OH number): | 249 |

### Example 1

### According to the Invention, Batch Preparation

1.5 g of bismuth(III) octoate were added as catalyst, under dry nitrogen, to 988 g (4.0 val) of IPDI polyisocyanate A1) with uretdione groups, and the mixture was heated to 80° C. A mixture of 430 g (3.2 val) of diol C1) with ester groups, 18 g (0.4 val) of 1,4-butanediol and 52 g (0.4 val) of 2-ethyl-1-hexanol was then added over 10 min, the temperature rising to 130° C. due to the heat of reaction evolved. After stirring for a further 10 minutes, the NCO content of the reaction mixture had fallen to a value of 0.7%. The melt was poured onto a metal sheet to cool; this gave a polyaddition compound containing uretdione groups according to the invention in the form of a colourless solid resin. The product had the following characteristics:

| | |
|---|---|
| content of uretdione groups (calc.): | 13.6% |
| monomeric IPDI: | <0.1% |
| NCO content: | 0.7% |
| melting range: | 80-84° C. |

### Example 2

### According to the Invention, Continuous Preparation

Apparatus used:

Static mixer with heating jacket, consisting of a mixing zone and a reaction zone with a total volume of 180 ml. The mixing element used in the mixing zone was an SMX 6 mixer from Sulzer (Winterthur, Switzerland) with a diameter of 6 mm and a length of 60.5 mm, and the mixing element used in the reaction zone was a Sulzer SMXL 20 mixer with a diameter of 20 mm and a length of 520 mm.

The educts were metered by means of an EK2 two-head piston metering pump from Lewa (Leonberg), specially equipped for feeding static mixers, with both the pump heads discharging simultaneously.

From a receiving piston A, IPDI polyisocyanate A1) with uretdione groups, heated under dry nitrogen to a temperature of 80° C., was continuously metered into the mixing zone of the static mixer at a rate of 1480 g (6.0 val) per hour. The piping between the receiver A and the pump and between the pump and the static mixer, and the appropriate pump head, were heated to a temperature of approx. 100° C.

At the same time, from another receiver B, a mixture of 85.7 wt. % of diol C1) with ester groups, 3.6 wt. % of 1,4-butanediol, 10.4 wt. % of 2-ethyl-1-hexanol and 0.3 wt. % of bismuth(III) octoate as catalyst was introduced into the mixing zone at a rate of 750 g (6.0 val) per hour. Because of the low viscosity of the polyol mixture, it was not necessary here to heat the receiver, piping and pump head.

The static mixer was heated to a jacket temperature of approx. 110° C. over the entire length. The mean residence time of the reaction melt was 5 min. The product leaving the static mixer at the end of the reaction zone at a temperature of approx. 140° C. was run onto metal sheets to cool. This gave a colourless solid with the following characteristics:

| | |
|---|---|
| content of uretdione groups (calc.): | 13.6% |
| monomeric IPDI: | <0.1% |
| NCO content: | 0.6% |
| melting range: | 82-85° C. |

### Example 3

### According to the Invention, Batch Preparation

1.3 g of bismuth(III) octoate were added as catalyst, under dry nitrogen, to 1000 g (4.0 val) of IPDI polyisocyanate A1) with uretdione groups, and the mixture was heated to 80° C. A mixture of 300 g (2.4 val) of diol C2) with ester groups and 30 g (0.8 val) of 1,3-propanediol was then added over 10 min, the temperature rising to 130° C. due to the heat of reaction evolved. After stirring for a further 10 minutes, the NCO content of the reaction mixture had fallen to a value of 2.7%. The melt was poured onto a metal sheet to cool; this gave a polyaddition compound containing uretdione groups according to the invention in the form of a colourless solid resin. The product had the following characteristics:

| | |
|---|---|
| content of uretdione groups (calc.): | 15.4% |
| NCO content (found/calc.): | 2.7/2.5% |
| total NCO content (calc.): | 17.9% |
| monomeric IPDI: | 0.3% |
| melting range: | 91-97° C. |

### Example 4

### According to the Invention, Continuous Preparation

A polyaddition compound containing uretdione groups was prepared by the process described in Example 2 using the apparatus described therein. 1480 g (6.0 val) per hour of IPDI uretdione A1) preheated to 80° C. were metered into the mixing zone from receiver A and 496 g (4.8 val) per hour of a catalyzed polyol mixture consisting of 90.4 wt. % of polyesterdiol C2), 9.2 wt. % of 1,3-propanediol and 0.4 wt. % of bismuth(III) octoate were metered in simultaneously from receiver B.

The static mixer was heated as in Example 2 and the mean residence time of the reaction melt was approx. 5 min. This gave a practically colourless solid with the following characteristics:

| | |
|---|---|
| content of uretdione groups (calc.): | 15.4% |
| NCO content (found/calc.): | 2.6/2.5% |
| total NCO content (calc.): | 17.9% |
| monomeric IPDI: | 0.2% |
| melting range: | 92-97° C. |

### Example 5

### According to the Invention, Continuous Preparation

A polyaddition compound containing uretdione groups was prepared by the process described in Example 2 using the apparatus described therein. 1480 g (5.0 val) per hour of 4,4′-diisocyanatodicyclohexylmethane uretdione A2) preheated to 80° C. were metered into the mixing zone from receiver A and 495 g (4.0 val) per hour of a catalyzed polyol mixture consisting of 95.0 wt. % of polyesterdiol C1), 4.6 wt. % of 1,4-butanediol and 0.4 wt. % of bismuth(III) octoate were metered in simultaneously from receiver B.

The static mixer was heated as in Example 2 and the mean residence time of the reaction melt was approx. 5 min. This gave a practically colourless solid with the following characteristics:

| | |
|---|---|
| content of uretdione groups (calc.): | 13.3% |
| NCO content (found/calc.): | 2.1/2.1% |
| total NCO content (calc.): | 15.4% |
| monomeric 4,4′-diisocyanatodicyclohexylmethane: | 0.2% |
| melting range: | 95-104° C. |

### Example 6

### According to the Invention, Batch Preparation

988 g (4.0 val) of IPDI polyisocyanate A1) with uretdione groups were reacted, by the process described in Example 1, with 430 g (3.2 val) of diol C1) with ester groups, 18 g (0.4 val) of 1,4-butanediol and 52 g (0.4 val) of 2-ethyl-1-hexanol in the presence of 1.5 g of bismuth(III) chloride as catalyst. This gave a polyaddition compound containing uretdione groups according to the invention in the form of a colourless solid resin with the following characteristics:

| | |
|---|---|
| content of uretdione groups (calc.): | 13.6% |
| monomeric IPDI: | <0.1% |
| NCO content: | 0.8% |
| melting range: | 79-85° C. |

### Example 7

### According to the Invention, Batch Preparation

988 g (4.0 val) of IPDI polyisocyanate A1) with uretdione groups were reacted, by the process described in Example 1, with 430 g (3.2 val) of diol C1) with ester groups, 18 g (0.4 val) of 1,4-butanediol and 52 g (0.4 val) of 2-ethyl-1-hexanol in the presence of 1.5 g of bismuth(III) neodecanoate as catalyst. This gave a polyaddition compound containing uretdione groups according to the invention in the form of a colourless solid resin with the following characteristics:

| | |
|---|---|
| content of uretdione groups (calc.): | 13.6% |
| monomeric IPDI: | <0.1% |
| NCO content: | 0.7% |
| melting range: | 79-83° C. |

### Example 8

### Comparative Example, Uncatalyzed, Batch Preparation

988 g (4.0 val) of IPDI polyisocyanate A1) with uretdione groups were heated under dry nitrogen to 80° C. A mixture of 430 g (3.2 val) of diol C1) with ester groups, 18 g (0.4 val) of 1,4-butanediol and 52 g (0.4 val) of 2-ethyl-1-hexanol was then added over 30 min and the reaction mixture was stirred at a reaction temperature of max. 105° C. until its NCO content had dropped to a value of 0.9% after 7 h. The melt was poured onto a metal sheet to cool; this gave a polyaddition compound containing uretdione groups in the form of a practically colourless solid resin with the following characteristics:

| | |
|---|---|
| content of uretdione groups (calc.): | 13.6% |
| monomeric IPDI: | 0.2% |
| NCO content: | 0.9% |
| melting range: | 83-85° C. |

### Example 9

### Comparative Example, DBTL Catalysis, Batch Preparation

988 g (4.0 val) of IPDI polyisocyanate A1) with uretdione groups were reacted, by the process described in Example 1, with 430 g (3.2 val) of diol C1) with ester groups, 18 g (0.4 val) of 1,4-butanediol and 52 g (0.4 val) of 2-ethyl-1-hexanol in the presence of 1.5 g of dibutyltin(IV) laurate (DBTL) as catalyst. This gave a polyaddition compound containing uretdione groups in the form of a colourless solid resin with the following characteristics:

| | |
|---|---|
| content of uretdione groups (calc.): | 13.6% |
| monomeric IPDI: | <0.1% |
| NCO content: | 0.8% |
| melting range: | 81-86° C. |

### Example 10

### Use in One-Shot Matt Powder Coatings; According to the Invention [a] and Comparative Example [b]

[a] 49.4 parts by weight of a commercially available polyester containing hydroxyl groups with an OH number of 38 (Rucote® XP 2566, Bayer MaterialScience A G, Leverkusen) and 16.4 parts by weight of a commercially available polyester containing hydroxyl groups with an OH number of 265 (Rucote® 109, Bayer MaterialScience A G, Leverkusen) were mixed thoroughly with 27.5 parts by weight of the polyaddition compound of Example 1 according to the invention, corresponding to an equivalent ratio of total NCO to OH of 0.8:1, 1.5 parts by weight of a commercially available flow control agent (Resiflow® PV 88, Worlée-Chemie GmbH, Hamburg), 0.5 part by weight of benzoin and 5.0 parts by weight of a black iron oxide pigment (Bayferrox® 303 T, Lanxess A G, Leverkusen) and the mixture was then homogenized by means of a Buss PLK 46 co-kneader at 100 rpm and a housing temperature of 100 to 120° C. in the processing section. After cooling, the solidified melt was ground and sieved by means of a classifier mill (ACM 2, Hosokawa Mikropul) with a 90 μm sieve.
[b] For comparison, a powder coating was prepared analogously from 49.4 parts by weight of Rucote® XP 2566 and 16.4 parts by weight of Rucote® 109 with 27.5 parts by weight of the polyaddition compound obtained in Comparative Example 9, 1.5 parts by weight of the flow control agent Resiflow® PV 88, 0.5 part by weight of benzoin and 5.0 parts by weight of the black iron oxide pigment Bayferrox® 303 T. The equivalent ratio of total NCO to OH was again 0.8:1.

Using an ESB rotary-cup spray gun at a high voltage of 70 kV, the two powder coatings obtained in this way were each sprayed in two different layer thicknesses onto degreased steel sheets and then cured for 10 min each, at a temperature of 200° C., to produce smooth-flowing, matt black coatings. The following lacquer properties were found:

Powder coating crosslinked with polyaddition compound of

| | | Example 1 | | Example 9 | |
|---|---|---|---|---|---|
| | | (according to the | | (Comparative Example | |
| | | invention [a]) | | [b]) | |
| Layer thickness [μm] | | 50-60 | 100-120 | 50-60 | 100-120 |
| Erichsen deep drawing | | 9.0 | 9.0 | 9.0 | 9.0 |
| according to DIN 53156 | | | | | |
| Acetone test^{a)} | DS | 50 | 50 | 50 | 50 |
| | Rating | 0-1 | 0-1 | 0-1 | 0-1 |

| | | | | |
|---|---|---|---|---|
| 60° gloss (DIN 67530) | 9 | 14 | 12 | 27 |

^{a)}DS: number of double strokes with impregnated wad of cotton wool
Rating: 0 = film intact 1 = film surface softened 2 = film swollen down to primer 3 = film dissolved m = matt (loss of gloss)

The comparison shows that fully crosslinked, elastic, solvent-resistant lacquer films can be obtained with both crosslinking agents, but that the coatings crosslinked with the polyaddition compound according to the invention, prepared under bismuth catalysis, exhibit a markedly lower gloss.

### Examples 11 to 14

### Use in One-Shot Matt Powder Coatings; According to the Invention

Black-pigmented matt powder coatings were prepared by the process described in Example 10 starting from the polyesters containing hydroxyl groups described in Example 10, i.e. Rucote® XP 2566 (OH number 38) and Rucote® 109 (OH number 265), and the polyaddition compounds of Examples 3, 5, 6 and 7 according to the invention. The equivalent ratio of total NCO to OH was 0.8:1 in all cases. Using an ESB rotary-cup spray gun at a high voltage of 70 kV, the ready-formulated powder coatings were each sprayed in two different layer thicknesses onto degreased steel sheets and then cured for 10 min each, at a temperature of 200° C., to produce smooth, matt black coatings. The Table below shows the compositions (parts by weight) of the powder coatings and the lacquer data for the coatings obtained therefrom.

| | | Example | | | | | | | |
|---|---|---|---|---|---|---|---|---|---|
| | | 11 | | 12 | | 13 | | 14 | |
| Rucote ® XP 2566 | | 53.2 | | 51.2 | | 49.4 | | 49.4 | |
| Rucote ® 109 | | 17.6 | | 17.0 | | 16.4 | | 16.4 | |
| Polyaddition compound of | | 22.5 | | — | | — | | — | |
| Example 3 | | | | | | | | | |
| Example 5 | | — | | 25.1 | | — | | — | |
| Example 6 | | — | | — | | 27.5 | | — | |
| Example 7 | | | | | | — | | 27.5 | |
| Resiflow ® PV 88 | | 1.2 | | 1.2 | | 1.2 | | 1.2 | |
| Benzoin | | 0.5 | | 0.5 | | 0.5 | | 0.5 | |
| Bayferrox ® 303 T | | 5.0 | | 5.0 | | 5.0 | | 5.0 | |
| Layer thickness [μm] | | 60 | 120 | 60 | 120 | 60 | 120 | 60 | 120 |
| Erichsen deep drawing according | | >9 | >9 | >9 | >9 | >9 | >9 | >9 | >9 |
| to DIN 53156 [mm] | | | | | | | | | |
| Acetone test^{a)} | DS | 50 | 50 | 50 | 50 | 50 | 50 | 50 | 50 |
| | Rating | 0 | 0 | 0 | 0 | 0-1 | 0-1 | 0-1 | 0-1 |

| | | | | | | | | |
|---|---|---|---|---|---|---|---|---|
| 60° gloss (DIN 67530) | 6 | 9 | 8 | 13 | 9 | 15 | 9 | 14 |

^{a)}See Example 10) for evaluation.

### Examples 15 to 17

### One-Shot Matt Powder Coatings; Comparative Examples

Black-pigmented matt powder coatings were prepared by the process described in Example 10 starting from the polyesters containing hydroxyl groups described in Example 10, i.e. Rucote® XP 2566 (OH number 38) and Rucote® 109 (OH number 265), and the uncatalyzed polyaddition compounds of Comparative Example 8. The equivalent ratio of total NCO to OH was 0.8:1 in all cases. One of the lacquers was extruded without a further addition of catalyst (Example 15), whereas 500 and 1000 ppm of bismuth(III) octoate were added as catalyst to two other lacquers prior to extrusion (Examples 16 and 17 respectively). The ready-formulated powder coatings were applied to steel sheets and cured as described in the previous Examples. The Table below shows the compositions (parts by weight) of the powder coatings and the lacquer data for the coatings obtained therefrom.

| | | Example (Comparative) | | | | | |
|---|---|---|---|---|---|---|---|
| | | 15 | | 16 | | 17 | |
| Rucote ® XP 2566 | | 49.4 | | 49.4 | | 49.4 | |
| Rucote ® 109 | | 16.4 | | 16.4 | | 16.4 | |
| Polyaddition compound | | 27.5 | | 27.5 | | 27.5 | |
| of Example 8 | | | | | | | |
| Bismuth(III) octoate | | — | | 500 ppm | | 1000 ppm | |
| Resiflow ® PV 88 | | 1.2 | | 1.2 | | 1.2 | |
| Benzoin | | 0.5 | | 0.5 | | 0.5 | |
| Bayferrox ® 303 T | | 5.0 | | 5.0 | | 5.0 | |
| Layer thickness [μm] | | 60 | 120 | 60 | 120 | 60 | 120 |
| Erichsen deep drawing | | >9 | >9 | >9 | >9 | >9 | >9 |
| according to DIN 53156 [mm] | | | | | | | |
| Acetone test^{a)} | DS | 50 | 50 | 50 | 50 | 50 | 50 |
| | Rating | 0-1 | 0-1 | 0-1 | 0-1 | 0-1 | 0-1 |

| | | | | | | |
|---|---|---|---|---|---|---|
| 60° gloss (DIN 67530) | 11 | 26 | 26 | 52 | 49 | 65 |

^{a)}See Example 10) for evaluation.

The comparison of Example 15 with Example 10 [a] according to the invention shows that, in one-shot matt powder formulations, the coatings obtained using a polyaddition compound containing uretdione groups prepared without catalysis have a higher gloss than those obtained using polyaddition compounds of the same gross composition prepared according to the invention under bismuth catalysis. Comparative Examples 16 and 17 prove that the gloss cannot be reduced by the subsequent addition of bismuth catalysts during the preparation of the powder coating, but, on the contrary, is even markedly increased.

### Example 18

### Use in High-Gloss Powder Coatings; According to the Invention [a] and Comparative Example [b]

[a] 50.7 parts by weight of a commercially available polyester containing hydroxyl groups with an OH number of 45 (Rucote® 194, Bayer MaterialScience A G, Leverkusen) were mixed thoroughly with 12.6 parts by weight of the polyaddition compound of Example 1 according to the invention, corresponding to an equivalent ratio of total NCO to OH of 1:1, 1.2 parts by weight of a commercially available flow control agent (Resiflow® PV 88, Worlée-Chemie GmbH, Hamburg), 0.5 part by weight of benzoin and 35.0 parts by weight of a white pigment (Kronos® 2160, Kronos Titan GmbH, Leverkusen) and the mixture was then homogenized by means of a Buss PLK 46 co-kneader at 100 rpm and a housing temperature of 100 to 120° C. in the processing section. After cooling, the solidified melt was ground and sieved by means of a classifier mill (ACM 2, Hosokawa Mikropul) with a 90 μm sieve.
[b] For comparison, a powder coating was prepared analogously from 50.7 parts by weight of Rucote® 194, 12.6 parts by weight of the polyaddition compound obtained in Comparative Example 9, 1.2 parts by weight of the flow control agent Resiflow® PV 88, 0.5 part by weight of benzoin and 35.0 parts by weight of the white pigment Kronos 2160. The equivalent ratio of total NCO to OH was again 1:1.

Using an ESB rotary-cup spray gun at a high voltage of 70 kV, the two powder coatings obtained in this way were sprayed onto degreased steel sheets and then cured for 18 min each, at a temperature of 180° C., to produce smooth-flowing, high-gloss coatings. The following lacquer properties were found:

Powder coating crosslinked with polyaddition compound of

| | | Example 1 | Example 9 |
|---|---|---|---|
| | | (according to the | (Comparative |
| | | invention [a]) | Example [b]) |
| Layer thickness [μm] | | 50-60 | 50-60 |
| Erichsen deep drawing | | >9 | >9 |
| according to DIN 53156 | | | |
| Acetone test^{a)} | DS | 50 | 50 |
| | Rating | 0-1 | 0-1 |

| | | |
|---|---|---|
| 60° gloss (DIN 67530) | 92 | 92 |

^{a)}See Example 10) for evaluation.

In the gloss powder coating formulation, the polyaddition compound prepared according to the invention under bismuth catalysis exhibits no disadvantages at all compared with a polyaddition compound of the same gross composition prepared under DBTL catalysis.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for the preparation of polyaddition products containing uretdione groups by the reaction of
A) polyisocyanates with uretdione groups having a mean isocyanate functionality of at least 2.0, optionally with the concomitant use of
B) other diisocyanates and/or polyisocyanates, different from A, in an amount of up to 70 wt. %, based on the total weight of components A) and B), with
C) polyols in the molecular weight range 62-2000 having a mean functionality of at least 2.0, or mixtures of polyols and optionally
D) other isocyanate-reactive monofunctional compounds in an amount of up to 40 wt. %, based on the total weight of components C) and D),
while maintaining an equivalent ratio of isocyanate groups to isocyanate-reactive groups of 1.8:1 to 0.6:1, wherein the reaction is carried out in the presence of at least one bismuth-containing catalyst.

2. Process according to claim 1, wherein the polyisocyanates A) with uretdione groups used are prepared from diisocyanates with aliphatically and/or cycloaliphatically bonded isocyanate groups, or mixtures of such polyisocyanates.

3. Process according to claim 1, wherein the polyisocyanates A) with uretdione groups used are prepared from 1,6-diisocyanatohexane, 1-isocyanato-3,3,5-trimethyl-5-isocyanatomethylcyclohexane, 2,4′-diisocyanatodicyclohexylmethane and/or 4,4′-diisocyanatodicyclohexylmethane, or mixtures of such polyisocyanates.

4. Process according to claim 1, wherein the polyols C) used are polyhydric alcohols in the molecular weight range 62 to 400, polyesterpolyols or polycarbonatepolyols, or any mixtures of such polyols.

5. Process according to claim 1, wherein the polyols C) used are diols in the molecular weight range 62 to 300, polyesterdiols or polycarbonatediols in the molecular weight range 134 to 1200, or any mixtures of such diols.

6. Process according to claim 1, wherein the polyols C) used are mixtures of polyesterdiols in the molecular weight range 134 to 1200 with up to 80 wt. %, based on the total weight of polyols C) used, of diols in the molecular weight range 62 to 300.

7. Process according to claim 1, wherein the reaction is carried out without a solvent.

8. Process according to claim 1, wherein bismuth(III) carboxylates are used as catalysts.

9. Process according to claim 1, wherein bismuth(III) octoate and/or bismuth(III) neodecanoate are used as catalysts.

10. Process according to claim 1, wherein the bismuth-containing catalysts are used in an amount of 0.001 to 2.0 wt. %, based on the total amount of starting compounds A) to D) used.

11. Polyaddition products containing uretdione groups, obtained by the process according to claim 1.

12. A polyurethane plastic prepared from the polyaddition products containing uretdione groups according to claim 11.

13. A polyurethane stoving lacquer prepared from polyaddition products containing uretdione groups according to claim 11, as crosslinking components.

14. A heat-curable polyurethane powder coating prepared from polyaddition products containing uretdione groups according to claim 11, as crosslinking components.

15. A powder coating having a matt surface prepared from the polyaddition products containing uretdione groups according to claim 11, in combination with at least one polyol having an OH number of 20 to 40 mg KOH/g and at least one polyol having an OH number of 200 to 300 mg KOH/g.
